(19) United States
(12) Patent Application Publication
(10) Pub. No.: US 2026/0266753 A1
(43) Pub. Date: Sep. 10, 2026

(54) HUMIDITY MEASURING DEVICE AND METHOD FOR OPERATING A HUMIDITY MEASURING DEVICE

(71) Applicant: E+E Elektronik Ges.m.b.H., Engerwitzdorf (AT)

(72) Inventors: Albin Haider, Alberndorf (AT); Joachim Gratzl, Leonding (AT)

(21) Appl. No.: 19/554,686

(22) Filed: Mar. 3, 2026

(30) Foreign Application Priority Data
Mar. 4, 2025 (DE) 10 2025 000 778.7

(51) Int. Cl. G01N 27/22; G01N 25/68

(52) U.S. Cl. CPC G01N 27/223; G01N 25/68

(57) ABSTRACT

A humidity measuring device, including a capacitive humidity sensor configured to determine a humidity content in a surrounding medium, a protective layer that surrounds the humidity sensor and is permeable to water molecules, and a temperature sensor configured to determine a temperature of the humidity sensor and of the surrounding medium. The humidity measuring device includes a controller, a heating element configured to heat the humidity measuring device to a defined heating temperature, and a cooling element configured to cool the humidity measuring device to a defined cooling temperature. The protective layer is configured such that it has a cooling period between the defined heating temperature and the defined cooling temperature shorter than a dead time, during which no water molecules pass through the protective layer to the humidity sensor once cooling has occurred and during which there is no change in signal from the humidity sensor.

### CROSS REFERENCE TO RELATED APPLICATIONS

This application claims benefit to German Patent Application No. DE 10 2025 000 778.7, filed on Mar. 4, 2025, which is hereby incorporated by reference herein.

### FIELD

The present invention relates to a humidity measuring device and to a method for operating a humidity measuring device.

### BACKGROUND

The measurement of the dew point of gases is an important process engineering and meteorological measurement task. The dew point or dew point temperature indicates the gas temperature above which the water contained in the gas condenses, or denotes the gas temperature at which a gas above a water surface is completely saturated with water vapor. In some cases, a dew point temperature below 0° C. is also referred to as the frost point temperature, which is the temperature at which a gas above an ice surface is completely saturated with water vapor. The dew point, on the other hand, refers to the temperature at which the gas over a water surface is completely saturated. Hereinafter, only the term dew point temperature will be used, even for dew point temperatures below 0° C.

Any condensation that occurs, for example in compressed air systems, will result in damage to the system and impaired quality of the final product. In building services engineering, for example, measuring devices for determining the dew point temperature (dew point meters, dew point monitors) are used to detect the risk of condensation, for example in air-conditioned ceilings, pipework, or switchgear cabinets, in good time before damage occurs. Dew point temperature monitoring is also necessary in drying processes and in the semiconductor industry. The dew point temperature is conventionally measured not directly but by measuring temperature and relative atmospheric humidity (hereinafter also referred to simply as humidity) and suitably calculating these variables, e.g., using “Sonntag's formulas”.

In the case of low dew point temperatures, the measured values that need to be acquired in relation to relative atmospheric humidity are only very small. This results in stringent requirements on the accuracy of the atmospheric humidity measurement. When capacitive humidity sensors are used, the change in capacitance of a suitable polymer is conventionally used as the measured variable for the relative humidity. A crucial limiting factor on the accuracy of the humidity measurement is knowledge of the “temperature cross-sensitivity” or temperature coefficient of the capacitive humidity sensor over the temperature range to be measured, which can change over the course of time. In addition to the influence of temperature on the accuracy of the humidity measurement, polymer aging, chemical influences, or indeed changes in the evaluation electronics used can also affect the humidity measurement. To ensure consistently highly accurate humidity measurement using capacitive humidity sensors, it is therefore important to know the influence of these effects as precisely as possible so that they can be separated from the actual humidity-dependent change in capacitance.

EP 4012393 A1 discloses a procedure for separating the temperature cross-sensitivity of the humidity sensor polymer used from an actual jump in humidity brought about by the atmospheric humidity that is truly present. It is proposed for this purpose to make the response time of the temperature measurement distinctly faster than the response time of the humidity measurement. This is to be achieved by way of a membrane structure of the humidity sensor that distinctly reduces the thermal mass of the humidity sensor. However, the solution proposed in said document does not permit the influence of temperature cross-sensitivity to be reliably separated from the actual humidity measurement. This is also attributable to the fact that the response time of the temperature measurement remains virtually constant as the temperature of the medium varies, while the response time of the humidity measurement becomes much faster at high temperatures. As a consequence, the difference between the differing response times varies depending on the temperature and thus makes it more difficult to reliably identify temperature cross-sensitivity.

### SUMMARY

In an embodiment, the present disclosure provides a humidity measuring device, comprising a capacitive humidity sensor configured to determine a humidity content in a surrounding medium, a protective layer that surrounds the humidity sensor and is permeable to water molecules, and a temperature sensor configured to determine a temperature of the humidity sensor and of the surrounding medium. The humidity measuring device further comprises a controller to which the output signals from the humidity sensor and the temperature sensor are configured to be supplied, a heating element configured to heat the humidity measuring device to a defined heating temperature, and a cooling element configured to cool the humidity measuring device to a defined cooling temperature. The protective layer is configured such that it has a cooling period between the defined heating temperature and the defined cooling temperature shorter than a dead time, during which no water molecules pass through the protective layer to the humidity sensor once cooling has occurred and during which there is no change in signal from the humidity sensor.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 illustrates a diagram providing a more detailed explanation of a known procedure for measuring humidity values to determine dew point temperature;

FIG. 2a illustrates a diagram showing the dependency of various variables on heating temperature in the procedure according to FIG. 1 at a dew point of −40° C.;

FIG. 2b illustrates a diagram showing the dependency of various variables on heating temperature in the procedure according to FIG. 1 at a dew point of −80° C.;

FIG. 3 illustrates a highly schematic diagram of an embodiment of the humidity measuring device according to the present disclosure;

FIG. 4 shows a diagram illustrating the temperature dependencies of a dead time of the humidity measuring device according to FIG. 3 with and without a protective layer;

FIG. 5 illustrates a diagram providing a more detailed explanation of a procedure according to the present disclosure for determining the temperature cross-sensitivity of the capacitive humidity sensor of the device according to FIG. 3;

FIG. 6a, FIG. 6b, and FIG. 6c each show diagrams illustrating the time curve of measured temperature and humidity values in the device of FIG. 3 during the procedure according to the present disclosure;

FIG. 7 illustrates a highly schematic diagram of an embodiment of the humidity measuring device according to the present disclosure;

FIG. 8 shows a diagram illustrating the temperature dependencies of the dead time of a capacitive humidity measuring device according to FIG. 7 with and without a protective layer;

FIG. 9 shows a diagram of the time curve of measured temperature and humidity values during a procedure according to the present disclosure; and

FIG. 10a, FIG. 10b, and FIG. 10c each show diagrams illustrating the time curve of measured temperature and humidity values in the device of FIG. 7 during a procedure according to the present disclosure.

### DETAILED DESCRIPTION

In an embodiment, the present disclosure provides a humidity measuring device and a method for operating a humidity measuring device in order to enable highly accurate measurement of even very small measured humidity values over an extended period of operation as well as precise determination and output of dew point temperature of a surrounding medium even at low dew point temperatures. In particular, an embodiment of the present disclosure ensures that the measured value change due to a change in humidity is separated as reliably as possible from other influences such as the temperature cross-sensitivity of the polymer, polymer aging, the temperature cross-sensitivity of the evaluation electronics, etc.

The humidity measuring device according to an embodiment of the present disclosure comprises:
a capacitive humidity sensor for determining the humidity content in a surrounding medium,
a protective layer that surrounds the humidity sensor and is permeable to water molecules,
a temperature sensor for determining the temperature of the humidity sensor and of the surrounding medium,
a control unit to which the output signals from the humidity sensor and the temperature sensor can be supplied,
a heating element for heating the humidity measuring device to a defined heating temperature, and
a cooling element for cooling the humidity measuring device to a defined cooling temperature.

The protective layer is configured such that its cooling period between heating temperature and cooling temperature is shorter than a dead time, during which no water molecules pass through the protective layer to the humidity sensor once cooling has occurred and during which there is no change in signal from the humidity sensor.

The protective layer can be configured as an organic protective layer and to have a thickness in the range 0.1 μm-100 μm.

The protective layer can also be configured as an inorganic protective layer and to have a thickness in the range 0.02 μm-10 μm.

At least the control unit, the temperature sensor, and the heating element are preferably arranged together in an integrated module.

The humidity sensor can also be configured as a plate capacitor and can be likewise arranged in the integrated module and be separated from the surrounding medium by the protective layer arranged over the plate capacitor.

In an embodiment, the cooling element is configured as a Peltier element.

In this case, the Peltier element can also act as a heating element and its respective functionalities can be adjustable by way of the control unit.

The cooling element can be configured as a metal cooling surface in a carrier element on which the integrated module is arranged, and convective cooling of the humidity measuring device can take place by way of the cooling surface.

The control unit is preferably configured and set up in such a way as to:
heat the humidity measuring device to the heating temperature and,
after a specific period at the heating temperature, cool the humidity measuring device to the cooling temperature, and
in the process, measured temperature values are determined continuously by way of the temperature sensor and measured humidity values are determined continuously by way of the humidity sensor until a constant measured humidity value is achieved after a specific period at the cooling temperature once cooling has occurred and the dead time has elapsed, whereby the measured humidity values are correctable with regard to influences that are not due to the change in humidity content in the surrounding medium.

The control unit can here be configured and set up in such a way as to carry out heating, cooling, and correction of the measured humidity values cyclically.

A method according to the present disclosure for operating a humidity measuring device, which comprises a capacitive humidity sensor for determining the humidity content in a surrounding medium, which humidity sensor is surrounded by a protective layer permeable to water molecules, provides that:
the humidity measuring device is heated to a heating temperature and,
after a specific period at the heating temperature, the humidity measuring device is cooled to a cooling temperature and,
after the cooling process, during a dead time in which no water molecules pass through the protective layer to the humidity sensor, there is no change in signal from the humidity sensor,
measured temperature values and measured humidity values being determined continuously until a constant measured humidity value is achieved after a specific period at the cooling temperature once cooling has occurred and the dead time has elapsed, whereby the measured humidity values are corrected with regard to influences that are not due to the change in humidity content in the surrounding medium.

Preferably:
the humidity measuring device is operated at the heating temperature at least for a period until there is a humidity equilibrium between the surrounding medium and the humidity sensor, and/or
the humidity measuring device is operated at the cooling temperature at least for a period until there is a humidity equilibrium between the surrounding medium and the humidity sensor.

The cooling period of the protective layer between heating temperature and cooling temperature is advantageously selected to be shorter than the dead time.

Cooling can take place actively or by convective cooling.

Heating, cooling, and correction of the measured humidity values are preferably carried out cyclically.

Using the measures according to the present disclosure, it is now made possible, under real measuring conditions at a constant temperature, to generate a defined change in humidity that can be clearly distinguished from other effects that have an impact on the generation of the measured humidity values by way of a capacitive humidity sensor. In this way, measured humidity values can be reliably corrected with regard to influences that are not due to the change in relative humidity, for example the above-stated temperature cross-sensitivity of the polymer used in the humidity sensor.

If an active cooling element, for example in the form of a Peltier element, is used, defined and rapid adjustment of a cooling temperature for the humidity measuring device is provided. Because of the humidity transformation that occurs in this process, cooling ensures a high-resolution humidity measurement; it also makes it possible to determine very low dew point temperatures of well below −80° C. without the need for elaborate systems, such as “dew point mirrors”.

Further details and advantages of the present disclosure will be explained on the basis of the following description of exemplary embodiments in conjunction with the drawings.

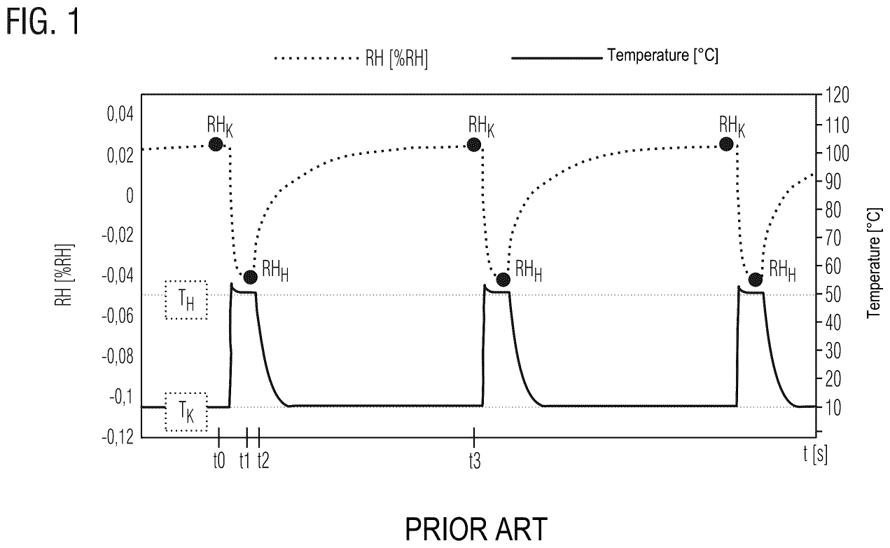

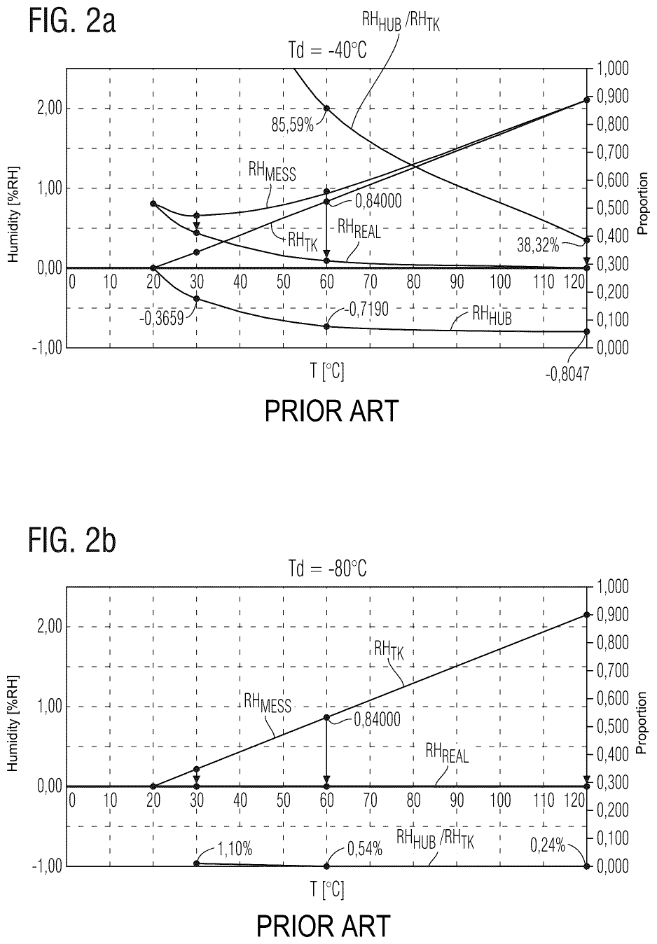

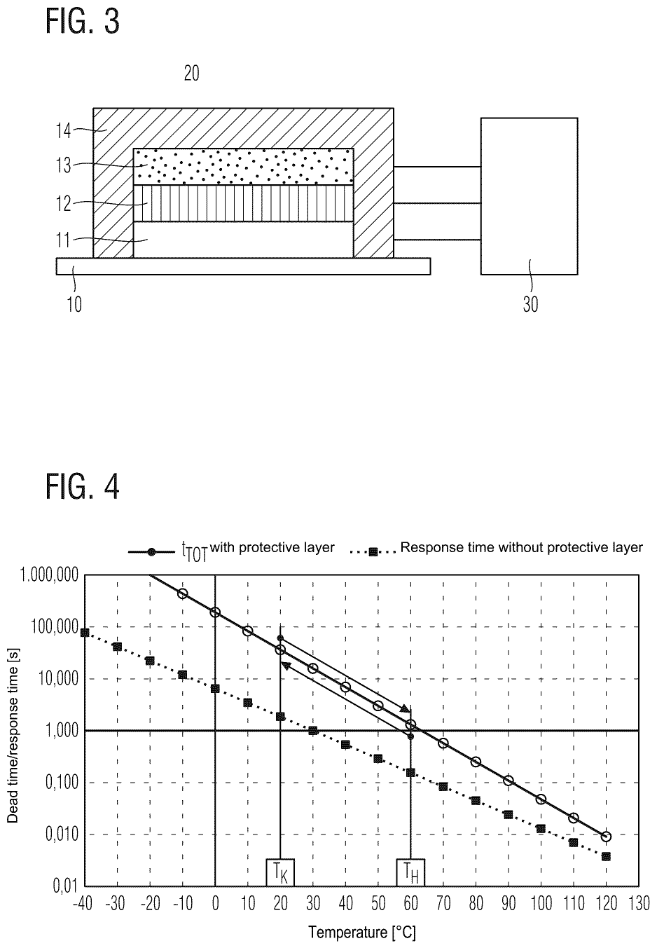

Before exemplary embodiments of the device or method according to the present disclosure are described in detail with reference to FIG. 3-10c, the known procedure for determining the temperature cross-sensitivity of a capacitive humidity sensor in a humidity measuring device will firstly be explained on the basis of FIGS. 1, 2a, and 2b.

Conventional capacitive humidity sensors are configured, for example, as plate capacitors having two opposing, planar electrodes between which there is arranged a polymer, the capacitance of which varies depending on humidity. In addition to the plate capacitor design, interdigital structures in which the polymer having humidity-dependent capacitance is arranged between interleaved finger-like electrodes are also known. In both design variants, the change in capacitance in the polymer is in each case converted into an electrical signal that can be further processed by downstream electronics.

The upper part of FIG. 1 shows the time curve of measured humidity values during the procedure described below, the left-hand y axis indicating the corresponding measured humidity values RH. The lower part of the figure shows the temperature curve over time, the right-hand y axis indicating the relevant measured temperature values T.

According to FIG. 1, at time t0 a measured value for humidity RH_{K} is determined by means of the capacitive humidity sensor, and a measured value for the temperature T_{K} of the surrounding medium is determined using a temperature sensor. Temperature T_{K} is also referred to as the cooling temperature hereinafter; in the present example, T_{K}=10° C. is selected. It should be noted that whenever humidity RH is mentioned here and below, the intended meaning is relative humidity measured using a suitable capacitive humidity sensor.

Following time t0, the humidity measuring device, comprising inter alia the capacitive humidity sensor and the temperature sensor, is heated until time t1 to a heating temperature T_{H}, and a measured value for humidity RH_{H} and temperature T_{H} is acquired; according to FIG. 1, the heating temperature T_{H} is T_{H}=50° C. As is furthermore apparent from FIG. 1, humidity drops to a very low value RH_{H} on heating. Once the heating is switched off, the temperature drops back down to the cooling temperature T_{K} and humidity rises back up until it reaches an approximately constant value RH_{K} at time t3. This procedure is repeated cyclically.

Using Sonntag's known formulas (Sonntag, D.: Important new values of the physical constants of 1986, vapour pressure formulations based on the ITS-90, and psychrometer formulae; Z. Meteorol., 70 (5), 1990, pp. 340-344), two dew point temperatures Td1, Td2 can now be determined from the pairs of measured humidity and temperature values as a function of the various measured values obtained. A first dew point temperature Td1 is obtained from the pair of measured values acquired at time t0 at cooling temperature T_{K}. Reproduced below in this respect are not the relationships according to Sonntag's formulas but merely the basic functional dependencies of the various dew point temperatures Td1, Td2 on the relevant variables:

$$Td 1 = f ( {RH}_{k} + {RH}_{OFFSET} , {T}_{K} ) \qquad ( eq . 1.1 )$$

where:
Td1:=first dew point temperature at time t0
RH_{K}:=measured humidity at time t0
T_{K}:=measured temperature at time t0 (cooling temperature)
RH_{OFFSET}:=humidity offset to correct systematic measurement errors, for example due to polymer aging, etc.

A second dew point temperature Td2 is obtained from the measured value for heating temperature T_{H} at time t1 and a humidity RH_{H}′ to be calculated at cooling temperature T_{K}:

$$( eq . 1.2 )$$

$$Td 2 := f ( {RH}_{H}^{′} + {RH}_{OFFSET} , {T}_{H} ) = f ( {RH}_{H} - {RH}_{TK} + {RH}_{OFFSET} , {T}_{H} ) = f ( R {H}_{H} - ( TK\_polymer ( {T}_{H} - {T}_{K} ) ) + {RH}_{OFFSET} , {T}_{H} )$$

where:
Td2:=second dew point temperature
RH_{H}′:=calculated humidity at cooling temperature T_{K}
RH_{OFFSET}:=humidity offset to correct systematic measurement errors, for example due to polymer aging, etc.
RH_{H}:=measured humidity at the heating temperature at time t1
RH_{TK}:=temperature-dependent correction variable for measured humidity RH_{H}, caused by temperature cross-sensitivity of the polymer, calculated according to

$$R {H}_{TK} := TK\_polymer ( {T}_{H} - {T}_{K} ) \qquad ( eq . 1.3 )$$

where
TK_polymer:=temperature cross-sensitivity of the polymer
T_{H}:=heating temperature
T_{K}:=cooling temperature

Assuming that no water molecules are added to or removed from the system during the temperature changes, the temperature increase does not result in any change in dew point temperature Td2 relative to dew point temperature Td1. It is thus made possible, by equating the dew point temperatures, i.e., Td1=Td2, to determine the humidity offset RH_{OFFSET} of the capacitive humidity sensor for which this equality applies.

The problem with this procedure is that the temperature cross-sensitivity TK_polymer of the polymer used for humidity measurement can change over the lifetime of the capacitive humidity sensor. Any such change then makes it impossible to distinguish whether a measured change in capacitance in the polymer is caused by a change in humidity and thus by a change in dew point temperature, or by possible structural changes in the polymer. Precise knowledge of the temperature cross-sensitivity TK_polymer of the particular polymer used for humidity measurement is thus fundamentally important for the accuracy of a capacitive humidity sensor over its lifetime.

Moreover, the dependency of the temperature cross-sensitivity TK_polymer on the particular dew point temperature must also be taken into account in this context. To illustrate this problem, reference is made to the diagram in FIG. 2a, which shows the temperature-dependent curve of certain variables in the temperature range between 20° C. and 120° C. at a dew point temperature Td=−40° C.

Specifically, the diagram shows the temperature-dependent curve of the measured humidity value RH_{MESS} measured by a capacitive humidity sensor, the curve of the actual measured humidity value RH_{REAL}, and the curve of the correction variable RH_{TK}. As is apparent from the figure, the correction variable RH_{TK} obtained according to the above equation 1.3 as

$$R {H}_{T K} = TK\_polymer ( {T}_{H} - {T}_{K} )$$

becomes ever greater as the temperature rises. The ratio of the measured wanted signal RH_{HUB}=RH_{H}−RH_{M}, i.e., the temperature-related change in humidity, to the correction variable RH_{TK} therefore becomes ever smaller as the temperature rises, and the corresponding temperature-dependent curve of this ratio is likewise illustrated in FIG. 2a. As is apparent from the figure, the ratio RH_{HUB}/RH_{TK} is around 86% at a temperature of 60° C. and only about 40% at a temperature of 120° C.

This effect is significantly heightened at even lower dew point temperatures Td. Reference is made in this connection to the analogous representation of the various variables in FIG. 2b, which illustrates the relationships at a dew point Td=−80° C. Here, the ratio RH_{HUB}/RH_{TK} is around 0.54% at a temperature of 60° C. and only 0.24% at a temperature of 120° C.

Determining the temperature cross-sensitivity TK_polymer thus becomes increasingly problematic at lower dew point temperatures because the change in humidity due to the temperature change likewise becomes ever smaller, while at the same time the correction variable RH_{TK} becomes ever greater at elevated temperatures. This means that the ratio of wanted signal to interfering signal increases. If the temperature is reduced, this ratio does indeed become more favorable again, but at the same time the requirements for accuracy of temperature measurement increase when determining the difference between the temperatures T_{H} and T_{K}. Overall, difficulties thus arise in reliably determining the temperature cross-sensitivity TK_polymer over the lifetime of the capacitive humidity sensor, which in turn has a negative impact on the accuracy of humidity measurement or dew point determination.

A first exemplary embodiment of the humidity measuring device according to the present disclosure, which avoids this problem and, in contrast, enables reliable correction of the temperature cross-sensitivity of a capacitive humidity sensor, is explained below with reference to FIG. 3-6c.

FIG. 3 is a highly schematic diagram of the first exemplary embodiment of the humidity measuring device according to the present disclosure, in which a heating element 11, a temperature sensor 12, and a capacitive humidity sensor 13 are arranged on a carrier element 10.

The heating element 11, the temperature sensor 12, and the humidity sensor 13 are furthermore completely surrounded by a protective layer 14 in the present exemplary embodiment of the device according to the present disclosure. The protective layer 14 is configured to be permeable to water molecules from the measuring chamber 20 surrounding the humidity measuring device. Alternatively, just the humidity sensor 13 can be surrounded by the protective layer 14.

The heating element 11 and the two sensors 12, 13 are furthermore connected to a control unit 30, which is likewise indicated only schematically. The heating element can be switched on and off by way of the control unit 30; the sensors 12, 13 transmit the obtained measured values regarding temperature and humidity to the control unit 30 for further processing. Further functions of the control unit 30 will be explained in detail later in the description.

In an embodiment, at least the control unit 30, the temperature sensor 12, and the heating element 11 are arranged together in an integrated module that is placed on the carrier element 10. The carrier element 10 is preferably configured as a thin (printed) circuit board onto which the integrated module is soldered.

The humidity measuring device can be heated to a defined heating temperature TH using the heating element 11, for which purpose the heating element 11 is appropriately activated by way of the control unit 30. A field-effect transistor (FET) used as a constant-current source can, for example, be provided as the heating element.

In the present exemplary embodiment, passive cooling of the humidity measuring device is provided in order to cool it from the heating temperature T_{H} to a defined cooling temperature T_{K} by natural convection; in this case, the cooling temperature T_{K} thus corresponds to the medium temperature T_{M}.

In this example, a suitable cooling element can be a metal cooling surface in the carrier element 10, for instance a copper plane in the printed circuit board to which the integrated module is thermally coupled. To this end, provision can be made to connect a thermal pad of the integrated module to the copper plane on the opposite side of the printed circuit board by way of a via. The copper plane here accordingly acts as a cooling surface or cooling element, by way of which passive convective cooling of the humidity measuring device is obtained. To ensure a good and rapid cooling action, provision is made in this example for the printed circuit board to be as thin and small as possible and for only narrow conductor tracks to be provided; a “flex circuit board” could, for example, be used. In general, for the cooling action it is advantageous for all the components of the humidity measuring device to have the lowest possible mass.

As an alternative to using a cooling surface, the cooling element can also take the form of a heat sink that has the lowest possible mass and the largest possible surface area in order to dissipate heat from the humidity measuring device to the surroundings. A “pin fin” heat sink which is arranged by way of a soldered joint on the carrier element in the form of a thin circuit board and which is thermally coupled to the thermal pad of the integrated module might, for example, be suitable for this purpose.

The temperature sensor 12, which is likewise indicated only schematically in FIG. 3, is used for determining the temperature of the humidity sensor 13 and of the surrounding medium in the measuring chamber 20. A PTAT CMOS temperature sensor can, for example, be considered as the temperature sensor 12.

The humidity content in the surrounding medium in the measuring chamber 20 is determined using the humidity sensor 13. If, as already mentioned above, the heating element 11, the temperature sensor 12, and the control unit 30 are arranged in an integrated module, the humidity sensor 13 can also be arranged therein, for example in the upper region of the integrated module, the humidity sensor 13 then being covered externally or toward the measuring chamber 20 by the protective layer 14.

The humidity sensor 13 is configured as a capacitive humidity sensor and preferably consists of or comprises a plate capacitor having a polymer arranged between the plate-shaped electrodes, the humidity-dependent change in capacitance of said polymer being convertible into an electrical signal and used as a measured variable for the humidity being determined. A capacitive humidity sensor of an interdigital design can also be used at this point.

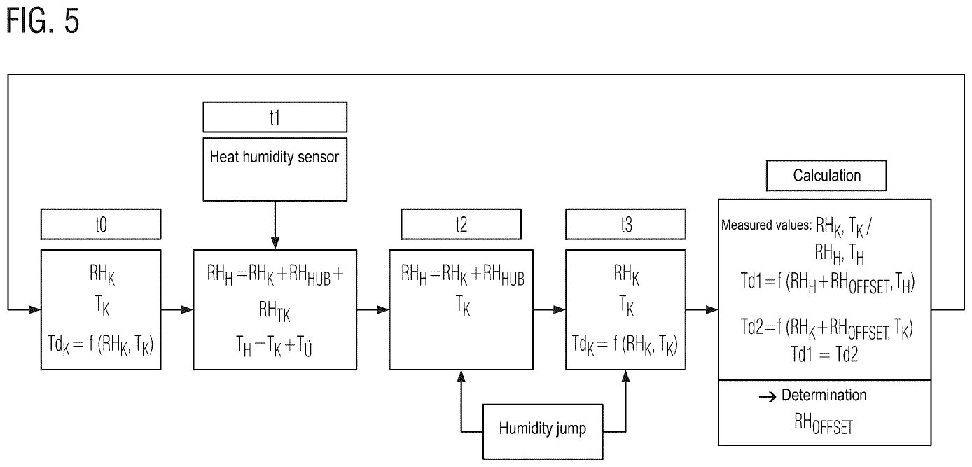

The specific configuration of the protective layer 14, which separates the humidity sensor 13 from the surrounding medium, is crucial to the humidity measuring device according to the present disclosure. The protective layer 14 must be penetrated by the humidity to be measured or the corresponding water molecules from the measuring chamber 20 so that humidity can be measured, or humidity-dependent electrical signals generated, by way of the capacitive humidity sensor 13. During the period in which the water molecules penetrate the protective layer 14, there is no change in signal on the part of the humidity sensor 13, i.e., humidity is not measured over this time. It is not until the water molecules reach the plate-shaped electrodes of the humidity sensor 13 that a humidity-dependent signal is generated. The protective layer 14 is accordingly responsible for a specific dead time t_{TOT}, within which no water molecules pass through the protective layer 14 and during which there is no change in signal from the humidity sensor 13. A diffusion process that is heavily dependent on the particular temperature is responsible for the dead time t_{TOT}; the higher the temperature, the faster the corresponding diffusion process or the shorter the relevant dead time t_{TOT}. Reference is made to FIG. 4 with regard to this correlation. This diagram shows, firstly, the dead time t_{TOT}, caused by a protective layer 14, of a capacitive humidity sensor 13 having a protective layer 14 over a temperature range [−40°C; +130°C]. Secondly, the diagram shows the distinctly shorter temperature-dependent response time of a capacitive humidity measuring device without a protective layer. The diagram of FIG. 4 highlights a temperature range between a cooling temperature T_{K}=20° C., which here corresponds to the medium temperature T_{M}, and a heating temperature T_{H}=60° C. As is apparent, the dead time t_{TOT} of the protective layer varies within this range between just under 100 sec at cooling temperature T_{K}=20° C. and around 1 sec at heating temperature T_{H}=60° C. and vice versa, when the humidity measuring device is heated and/or cooled in this temperature range. As is likewise apparent, the response times of the humidity measuring device without a protective layer are distinctly shorter in this temperature range.

The protective layer 14 in the humidity measuring device according to the present disclosure is suitably designed or configured by way of materials selection and/or adjustment of the thickness of the protective layer 14. The protective layer 14 is configured such that its cooling period t_{COOL} between a heating temperature T_{H} and a cooling temperature T_{K} is shorter than the dead time t_{TOT}, during which no water molecules pass through the protective layer 14 to the humidity sensor 13 once cooling has occurred and during which there is no change in signal from the humidity sensor 13. Not only the protective layer 14 but also the moisture-sensitive polymer of the humidity sensor cools to the cooling temperature T_{K} within the dead time t_{TOT}.

During material selection, care must furthermore be taken to select a material for the protective layer 14 that, as far as possible, does not store humidity or water molecules but instead ensures good onward transport of the humidity.

Organic protective layers by way of which the aforementioned properties can be adjusted can be considered for the protective layer 14. Suitable materials are, for example, polyurethanes, acrylics, silicones, epoxides, polyimides, polybenzoxazoles, polycarbonates, polysulfones, polybenzimidazoles, or polyamides. Suitable protective layer thicknesses for such materials are in the range 0.1 μm-100 μm.

Alternatively, inorganic materials exhibiting suitable permeability to humidity could also be used for the protective layer 14. In this case, a somewhat smaller thickness of the protective layer 14 in the range 0.02 μm-10 μm can be selected.

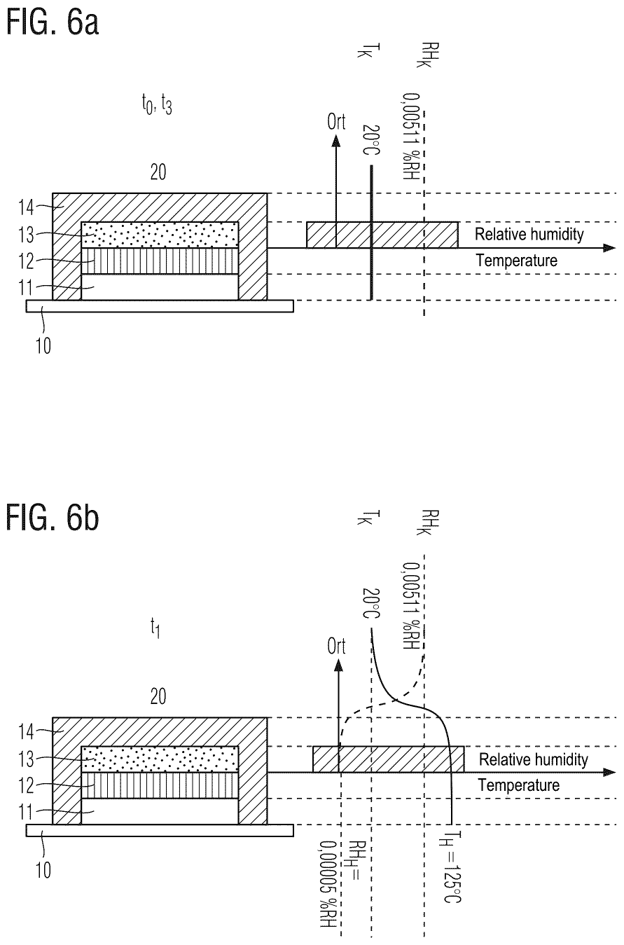

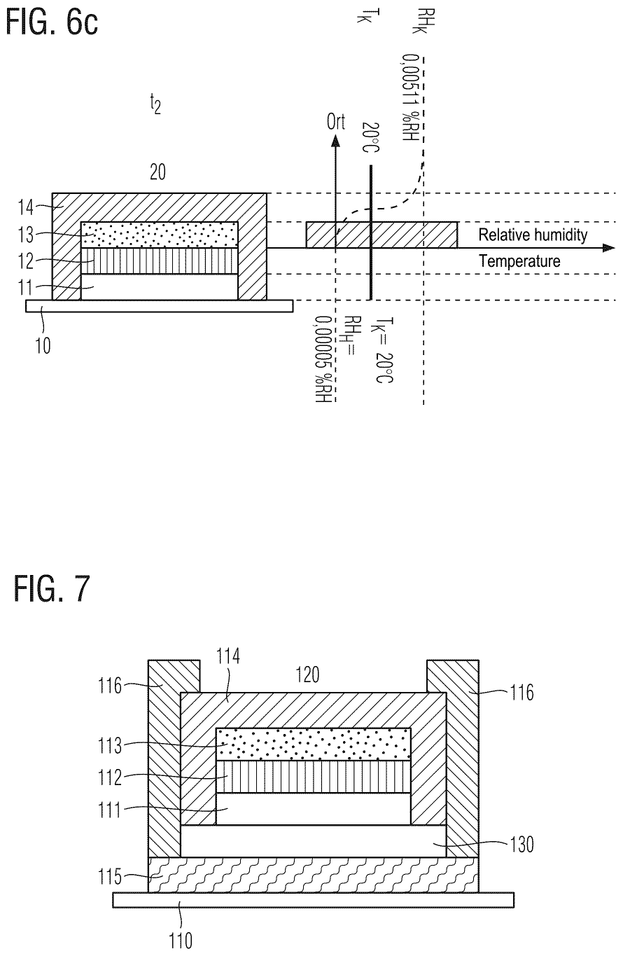

A procedure by which the measured humidity values obtained by means of the humidity measuring device from FIG. 3 can be corrected, using said humidity measuring device, with regard to influences which are not attributable to the change in humidity content in the surrounding medium will now be described below with reference to FIG. 5 and 6a-6c. FIG. 5 shows a flow chart including the measurements and calculations that take place at specific times t0-t3. FIG. 6a-6c each show part of the humidity measuring device from FIG. 3 and the location-dependent temperature and humidity curve at times t0, t1, and t2. The crosshatched region in the right-hand part of FIG. 6a-6c is in each case intended to illustrate the temperature and humidity conditions that are prevailing in the region of the humidity sensor and currently being measured by the humidity sensor and converted into electrical signals.

At time t0, there is a stable equilibrium state in respect of temperature T_{K}, humidity RH_{K}, and dew point Td_{K}. As explained above, the dew point Td_{K} is obtained from Sonntag's formulas as a function of humidity RH_{K} and temperature T_{K} at time t0, i.e., Td_{K}=f(RH_{K}, T_{K}). At time t0, these parameters can be, for example:

$$T {d}_{K} = - 80 ° C .$$

$${T}_{K} = 20 ° C .$$

$${RH}_{K} = 0.00511 \%$$

The corresponding temperature and humidity conditions in the humidity measuring device at time t0 are illustrated in a location-dependent manner in FIG. 6a. As is apparent therefrom, identical conditions with regard to constant values of temperature T_{K} and humidity RH_{K} are present along a vertical section line through the humidity measuring device.

A heating process using the heating element 11 is then started by way of the control unit 30, in which the device having the temperature sensor 12, the humidity sensor 13, and the protective layer 14 is heated to the heating temperature T_{H}, which is reached at time t1. The humidity measuring device is operated at the heating temperature T_{H} at least for a period until there is a humidity equilibrium between the surrounding medium and the humidity sensor 13. In the example shown, the heating temperature T_{H} is T_{H}=125° C., the heating temperature being obtained according to

$${T}_{H} = {T}_{K} + {T}_{\ddot{U}} \qquad ( eq . 2 )$$

with the variable T_{Ü} representing the temperature rise or the difference between temperature T_{K} at time t0 and heating temperature T_{H} at time t1.

As a result of heating, the humidity RH_{H} measured by way of the humidity sensor 13 drops to such an extent that the dew point temperature Td_{H} is identical at the humidity sensor 13 and in the measuring chamber 20. If no water molecules are removed from or added to the system during the temperature changes, Td_{K}=Td_{H}=−80° C. still applies. In the present example, the humidity measurement at time t1 yields a humidity RH_{H}=0.00005%, i.e., a humidity differing only insignificantly from a humidity RH≈0%. The ratio of the measured humidity levels RH_{K} and RH_{H} at times t0 and t1 is thus approximately 1:100 at dew point temperature Td=−80° C.

The humidity RH_{H} at heating temperature T_{H} measured at time t1 by way of the humidity sensor 13 is due, as already explained above, to the proportion RH_{HUB} caused by the temperature change and to a proportion RH_{TK} caused by the temperature cross-sensitivity of the polymer used, i.e.,

$$R {H}_{H} = R {H}_{K} + R {H}_{HUB} + R {H}_{TK} \qquad ( eq . 4 )$$

Due to the elevated heating temperature T_{H}, the resultant dead time t_{TOT} in the protective layer 14 and thus also the response time of the humidity sensor 13 is relatively short. The various equalization processes in the humidity measuring device thus take place very quickly and cannot readily be distinguished from the response time of the temperature sensor 12.

FIG. 6b again illustrates the location-dependent curve of the temperature and humidity in the humidity measuring device during the heating process at time t1.

Once the equalization processes are complete and constant measured humidity and temperature values RH_{H}, T_{H} have been reached, the heating process is ended and the heating element 11 switched off by way of the control unit 30. The temperature of the humidity sensor 13, the temperature sensor 12, and the protective layer 14 then drops rapidly. Due to the above-mentioned temperature dependency of the dead time t_{TOT} of the protective layer 14, the dead time t_{TOT} increases significantly with decreasing temperature, as a result of which the equalization of humidity between the humidity sensor 13 and the surrounding medium is delayed until the temperature at time t2 has dropped back down to temperature T_{K}.

It is therefore crucial to the procedure according to the present disclosure that, due to the resultant dead time t_{TOT} caused by the protective layer 14, the measured humidity RH_{H} is virtually 0% at time t2, although the temperature of the humidity sensor has already dropped back down to temperature T_{K} of the medium in the measuring chamber 20, with T_{K}=T_{M} applying in this example as mentioned above.

FIG. 6c shows the location-dependent curve of temperature and humidity in the humidity measuring device at time t2 after the heating element has been switched off and during the dead time t_{TOT}.

If the temperature T_{K} and humidity RH_{K} in the surrounding medium remain unchanged, the measured humidity then subsequently rises back up after a certain time from the value RH_{H} to the value RH_{K} at time t3. The humidity measuring device is operated at the cooling temperature T_{K} at least for a period until there is a humidity equilibrium between the surrounding medium and the humidity sensor 13. By way of the explained procedure, a humidity jump from a humidity value RH_{H} to the humidity value RH_{K} at temperature T_{K} is produced by means of the device according to the present disclosure in the period between times t2 and t3, said jump being measurable without cross-influences such as the temperature cross-sensitivity of the polymer used in the capacitive humidity sensor 13. This humidity jump corresponds to the above-mentioned variable RH_{HUB}, i.e., the change in humidity caused by the temperature change.

The humidity offset RH_{OFFSET} can subsequently be calculated by the control unit 130 from the obtained measured values T_{H} at time t1, RH_{H} at time t2, or the measured values RH_{K}, T_{K} at time t3. It is again assumed that the dew points Td1 and Td2 at times t1, t2, t3 are identical if no water molecules are removed from or added to the system during the temperature changes. The corresponding procedure involving heating, cooling, and ascertaining the humidity offset RH_{OFFSET} is then repeated cyclically, for example at 45-minute intervals or if the ambient conditions of the medium to be measured change rapidly.

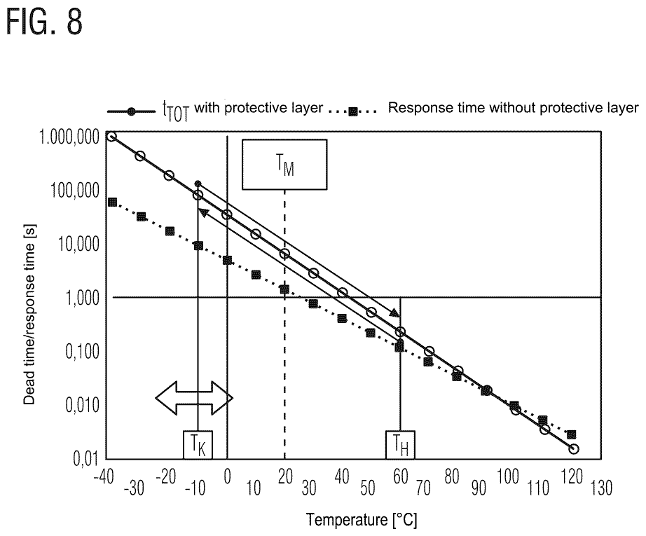

A second exemplary embodiment of the humidity measuring device according to the present disclosure, which enables reliable correction of the temperature cross-sensitivity of a capacitive humidity sensor, is explained below with reference to FIGS. 7, 8, 9, and 10a-10c, the differences and characteristic features compared with the first exemplary embodiment essentially being addressed here.

Analogously to the first exemplary embodiment, FIG. 7 is a highly schematic diagram of the second exemplary embodiment of the humidity measuring device according to the present disclosure, in which the crucial components are now arranged in an integrated module.

Here, a cooling element 115, which in this example is configured as an active cooling element in the form of a Peltier element, is arranged on a carrier element 110. Using the active cooling element 115, the humidity measuring device can be cooled a cooling temperature T_{K} that can even be distinctly below the medium temperature T_{M} in the surrounding measuring chamber 120, i.e., typically T_{K}≠T_{M} here. Energy required for operating the cooling element 115 can additionally be dissipated by way of the carrier element 110, such that the cooling effect on the other components of the humidity measuring device is not impaired. The various advantages associated with using an active cooling element 115 in the humidity measuring device according to the present disclosure will be explained in the course of the further description.

In the present exemplary embodiment, an integrated module comprising a control unit 130, a heating element 111, a temperature sensor 112, and a humidity sensor 113 having a protective layer 114 arranged thereover is arranged on or above the cooling element 115. The integrated module is arranged above the cooling element 115 within a housing 116 that is likewise indicated only highly schematically. Solely above the protective layer 114, the housing 116 has an access opening through which water molecules from the measuring chamber 120 can pass through the protective layer 114 to the humidity sensor 113. The control unit 130 is connected to the cooling element 115, the heating element 111, the temperature sensor 112, and the humidity sensor 113 by way of electrical connections. The heating or cooling element 111, 115 can be appropriately activated by way of these connections, while the measured values from the temperature and humidity sensors 112, 113 are moreover transmitted thereover to the control unit 130. It is not in principle essential for the heating element 111 and the cooling element 115 to be activated by way of the control unit 130—this can alternatively also be carried out by way of external electronics.

The variant of the humidity measuring device according to the present disclosure having an active cooling element 115 shown in FIG. 7 could also advantageously be used in a dew point temperature measuring device as known from EP 4650765 A1. The two humidity sensor units provided therein can be configured in accordance with the structure of the present disclosure shown in FIG. 7, in which case a separate cooling element would no longer be required for the second humidity sensor unit.

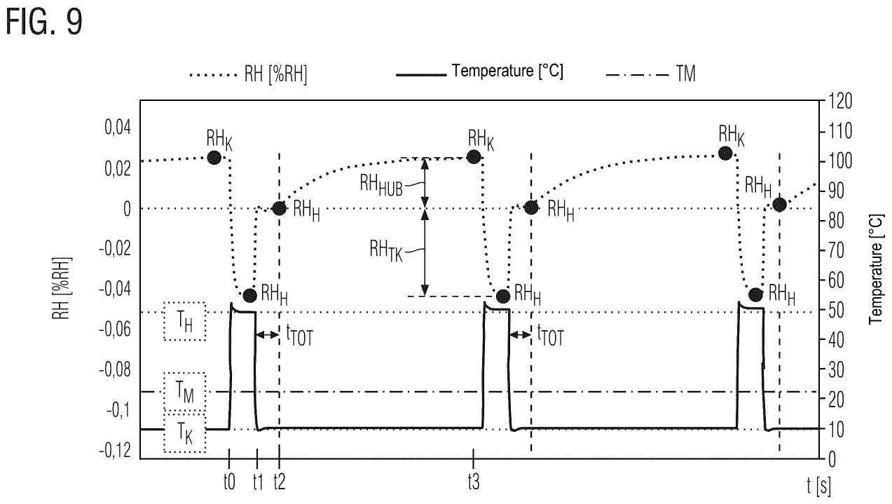

As in FIG. 4, FIG. 8 again shows the relationship between the protective layer dead time t_{TOT} or response time of the humidity measuring device and the temperature for the cases with and without a protective layer.

In this exemplary embodiment, the cooling temperature T_{K} can now also be adjusted independently of the medium temperature T_{M}, i.e., T_{K}≠T_{M}, by way of the active cooling element 115. This means that the entire temperature range between the heating and cooling temperatures T_{H}, T_{K} can be selected particularly advantageously or as required, in particular independently of the current medium temperature T_{M}. Instead of the passive cooling process once the heating element has been switched off according to the first exemplary embodiment, in this case the active cooling element 115 provides closed-loop control toward the desired cooling temperature T_{K}, which has a specific dead time t_{TOT}. By way of such closed-loop control toward the desired cooling temperature T_{K}, the cooling rate can be increased, which in turn shortens the dead time t_{TOT} of the protective layer 114. As is apparent from FIG. 8, rapid cooling to T_{K}=20° C. results in a dead time of t_{TOT}=8 sec, whereas, in the case of distinctly slower cooling without an active cooling element 115 to the same temperature T_{K}=20° C., the dead time is t_{TOT}=40 sec. Active cooling to a desired cooling temperature T_{K} using the cooling element 115 thus allows the system to be adjusted distinctly more quickly.

By using an active cooling element 115, the advantage of “humidity transformation” can also be used. This means that a higher relative humidity is obtained at very low dew point temperatures, thus enabling distinctly more accurate measurements. This is explained below with reference to a specific example.

For instance, with the heating element 111 and the cooling element 115 switched off at time t0 at a dew point temperature Td=−80° C. and a medium temperature T_{M}=20° C., a measured humidity RH_{M}=0.00511% is obtained.

After the heating element 111 is switched on, a measured heating temperature T_{H}=125° C. and a measured humidity RH_{H}=0.00005%, i.e., a measured humidity value close to 0%, are obtained at a time t1 at the same dew point temperature Td=-80° C. The lower the dew point temperature, the lower too the corresponding measured humidity value RH_{H}.

If the device is cooled by way of an active cooling element 115 to a cooling temperature T_{K}=−40° C., a humidity RH_{K}=0.62694% is measured at a time t0 or t3 in an equilibrium state. The measured humidity value RH_{K} is accordingly greater than the measured humidity value without active cooling by more than a factor of 100. This effect corresponds to the above-mentioned humidity transformation and offers considerable advantages in terms of measurement accuracy. For instance, the ratio of measured humidity levels at times t1 (RH_{H}=0.00005%) and t3 (RH_{H}=0.62694%) at a dew point temperature Td=−80° C. is around 1:12,539; active cooling thus results in a humidity uplift that is higher by more than a factor of 100, and therefore also in improved resolution in the dew point measurement.

Due to the active cooling, the cooling temperature T_{K} thus no longer has to correspond to the medium temperature T_{M} but can instead be suitably selected by means of the cooling element 115. By cooling the air in the surroundings of the humidity measuring device, the (relative) humidity in the air rises there, is transported onward through the protective layer 114 to the humidity sensor 113, and can thus be determined by measurement. The temperature difference to be achieved between heating temperature T_{H} and cooling temperature T_{K} is thus limited only by the cooling capacity of the cooling element 115.

In relation to this exemplary embodiment, the procedure according to the present disclosure essentially corresponds to that explained in detail for the first exemplary embodiment on the basis of FIG. 5. The only difference compared with the present example is that now, after heating, active cooling to the cooling temperature T_{K} takes place instead of passive cooling to the medium temperature T_{M}. In the present case, the cooling temperature T_{K} is accordingly not equal to the medium temperature T_{M} and is typically selected to be lower than the medium temperature T_{M}.

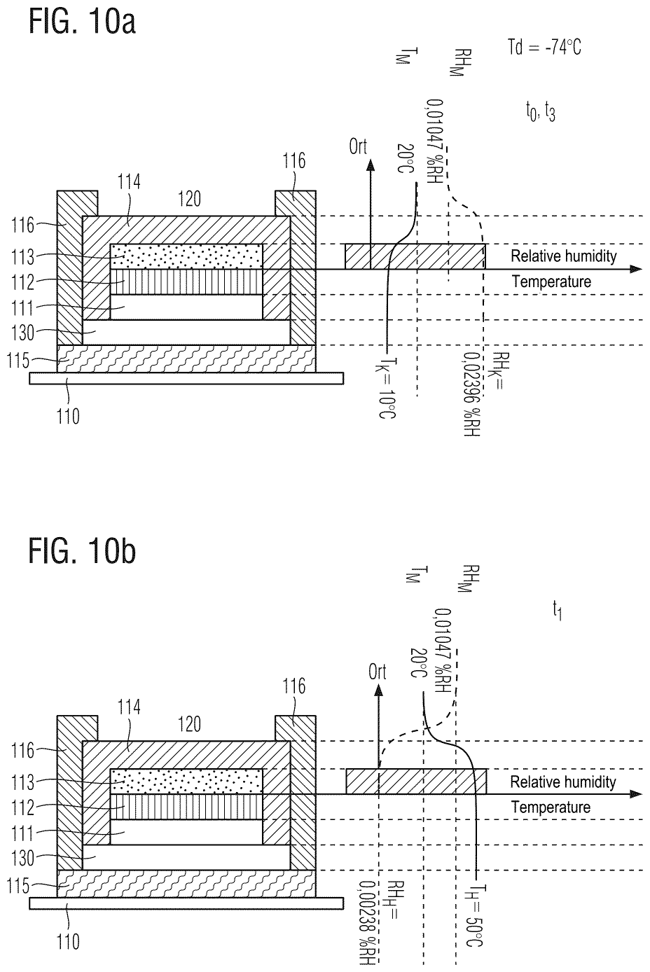

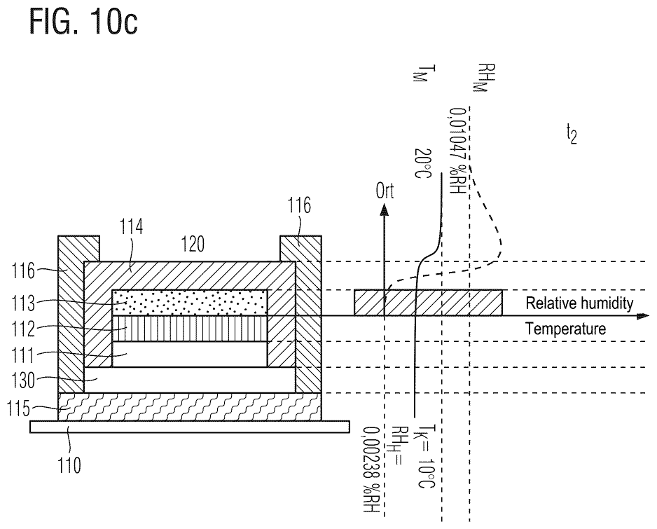

The procedure by which the measured humidity values obtained by means of the humidity measuring device from FIG. 7 can be corrected, using said humidity measuring device, with regard to influences which are not attributable to the change in humidity content in the surrounding medium will be described below with reference to FIG. 9 and 10a-10c. The upper part of FIG. 9 shows the time curve of the measured humidity values during the procedure according to the present disclosure in the second exemplary embodiment, with the left-hand y axis indicating the corresponding measured humidity values RH. The lower part of the figure shows the temperature curve over time, the right-hand y axis indicating the relevant measured temperature values T. The procedure shown here takes place at a dew point temperature Td=−74° C. and with active cooling from a heating temperature T_{H}=50° C. to a cooling temperature T_{K}=10° C. at a medium temperature T_{M}=23° C., i.e., T_{K}≠T_{M}. FIG. 10a-10c each show part of the humidity measuring device from FIG. 7 and the location-dependent temperature and humidity curve at times t0, t1, and t2. The crosshatched region in the right-hand part of FIG. 10a-10c is in each case intended to illustrate the environmental conditions that are currently being measured by the humidity sensor 113 and converted into electrical signals.

In the example shown for a dew point temperature Td=−74° C., a heating temperature T_{H}=50° C. and a cooling temperature T_{K}=10° C. are provided at a medium temperature T_{M}=23° C.

FIG. 10a shows the conditions in an equilibrium state at time t0 or t3. At this time, the heating element 111 is switched off and the cooling element 115 is switched on such that a medium temperature T_{M}=23° C. is present in the measuring chamber 120 and a cooling temperature T_{K}=10° C. is present in the humidity measuring device according to the present disclosure. A humidity RH_{M}=0.01047% is furthermore present in the measuring chamber, and a humidity RH_{K}=0.02396% is measured by the humidity sensor 113 in the device according to the present disclosure.

The heating element 111 is then switched on and the cooling element 115 switched off. FIG. 10b shows the conditions at time t1. A heating temperature T_{H}=50° C. is present in the humidity measuring device, and humidity has dropped to the value RH_{H}=0.00238%. The humidity is not yet determined by way of the humidity sensor 113 at this time, this phase primarily serving to adjust the humidity RH_{H} at the humidity sensor 113.

The heating element 111 is then switched off and the cooling element 115 switched on. Once the humidity sensor 113 and the protective layer 114 have cooled down, the humidity RH_{H}=0.00238% is then measured by way of the humidity sensor 113 at the cooling temperature T_{K}=10° C. at time t2, as illustrated in FIG. 10c, shortly before the dead time t_{TOT} elapses. It is crucial here that the measured humidity RH_{H} is still virtually 0% because the dead time t_{TOT} has not yet completely elapsed, despite the measured temperature in the humidity measuring device already having dropped back down to the cooling temperature T_{K}=10° C.

The humidity subsequently penetrates the protective layer 114 such that, as is apparent from FIG. 9, the humidity measured by way of the humidity sensor begins to rise after the dead time t_{TOT} until at time t3 a humidity RH_{K}=0.02396% is again present at cooling temperature T_{K}=10° C., as measured by way of the humidity sensor 113.

Because a cooling element 115 is used to cool the humidity sensor 113 and the protective layer 114, the cooling temperature T_{K} can be adjusted in this exemplary embodiment independently of the temperature T_{M} of the medium to be measured, providing the cooling element 115 has the cooling capacity required for this purpose. The cooling element 115 and the protective layer 114 are designed such that the dead time t_{TOT} is identifiable at any medium temperature T_{M} and thus an actual humidity jump at temperature T_{K} at times t2 and t3 between the humidity levels RH_{K} and RH_{H} is measurable, said jump being independent of other influences such as the temperature cross-sensitivity of the polymer used in the capacitive humidity sensor 113. This allows the temperature cross-sensitivity TK_polymer to be determined according to TK_polymer=RH_{TK}/(T_{H}−T_{K}) by measuring temperatures T_{K} and T_{H} at times t2 and t3 or humidity RH_{H} at time t2 using the above-mentioned equation 1.3; reference is also made to FIG. 9 in this regard. The variable determined in this way then corresponds to an average temperature cross-sensitivity between temperatures T_{H} and T_{K}.

In this exemplary embodiment, active cooling furthermore results in a multiplication of the measurement signal for relative humidity, which in particular results in a distinctly increased resolution in the determination of very low dew point temperatures. This enables either measurement of dew point temperatures down to Td=−125° C. or alternatively distinctly higher accuracy in the measurement of dew point temperatures that are not quite so low, for instance for dew point temperatures Td=−80° C.

In addition to the specifically described exemplary embodiments and alternatives previously explained, there are of course still further developments provided within the scope of the present disclosure.

For instance, as already indicated in the above-described first exemplary embodiment having passive cooling, there are further options for providing suitable cooling elements.

The second exemplary embodiment can be modified such that no separate heating element is provided therein, but the cooling element configured as a Peltier element is instead also used as a heating element by its functionality being adjustable by way of the control unit. For example, the Peltier element can also be used as a heating element by having its polarity reversed by way of the control unit at the appropriate times.

Furthermore, if the temperature sensor is, for example, configured as a temperature-dependent resistor, the temperature sensor can simultaneously act as a heating element, etc.

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

1. A humidity measuring device, comprising:
a capacitive humidity sensor configured to determine a humidity content in a surrounding medium;
a protective layer that surrounds the humidity sensor and is permeable to water molecules;
a temperature sensor configured to determine a temperature of the humidity sensor and of the surrounding medium;
a controller configured to receive output signals from the humidity sensor and the temperature sensor;
a heating element configured to heat the humidity measuring device to a defined heating temperature; and
a cooling element configured to cool the humidity measuring device to a defined cooling temperature,
wherein the protective layer is configured such that it has a cooling period between the defined heating temperature and the defined cooling temperature shorter than a dead time, during which no water molecules pass through the protective layer to the humidity sensor once cooling has occurred and during which there is no change in signal from the humidity sensor.

2. The humidity measuring device according to claim 1, wherein the protective layer is configured as an organic protective layer and has a thickness in a range of 0.1 μm-100 μm.

3. The humidity measuring device according to claim 1, wherein the protective layer is configured as an inorganic protective layer and has a thickness in a range of 0.02 μm-10 μm.

4. The humidity measuring device according to claim 1, wherein at least the controller, the temperature sensor, and the heating element are arranged together in an integrated module.

5. The humidity measuring device according to claim 4, wherein the humidity sensor is configured as a plate capacitor and is also arranged in the integrated module and is separated from the surrounding medium by the protective layer arranged over the plate capacitor.

6. The humidity measuring device according to claim 1, wherein the cooling element is configured as a Peltier element.

7. The humidity measuring device according to claim 6, wherein the Peltier element also acts as a heating element and its respective functionalities are adjustable by the controller.

8. The humidity measuring device according to claim 4, wherein the cooling element is configured as a metal cooling surface in a carrier element on which the integrated module is arranged, and wherein convective cooling of the humidity measuring device takes place by way of the cooling surface.

9. The humidity measuring device according to claim 1, wherein the controller is configured to:
heat the humidity measuring device to the defined heating temperature,
after a specific period at the defined heating temperature, cool the humidity measuring device to the defined cooling temperature,
wherein in the process of heating the humidity measuring device and cooling the humidity measuring device, measured temperature values are determined continuously by the temperature sensor and measured humidity values are determined continuously by the humidity sensor until a constant measured humidity value is achieved after a specific period at the defined cooling temperature once cooling has occurred and the dead time has elapsed, and
correct the measured humidity values with regard to influences that are not due to a change in humidity content in the surrounding medium.

10. The humidity measuring device according to claim 9, wherein the controller is configured to carry out the heating, cooling, and correction of the measured humidity values cyclically.

11. A method for operating a humidity measuring device, the humidity measuring device comprising a capacitive humidity sensor for determining a humidity content in a surrounding medium, the humidity sensor being surrounded by a protective layer permeable to water molecules, the method comprising:
heating the humidity measuring device to a heating temperature;
after a specific period at the heating temperature, cooling the humidity measuring device to a cooling temperature;
after the cooling, during a dead time in which no water molecules pass through the protective layer to the humidity sensor and there is no change in signal from the humidity sensor, continuously determining measured temperature values and measured humidity values until a constant measured humidity value is achieved after a specific period at the cooling temperature once cooling has occurred and the dead time has elapsed; and
correcting the measured humidity values with regard to influences that are not due to a change in humidity content in the surrounding medium.

12. The method according to claim 11, wherein:
the humidity measuring device is operated at the heating temperature at least for a period until there is a humidity equilibrium between the surrounding medium and the humidity sensor, and/or
the humidity measuring device is operated at the cooling temperature at least for a period until there is a humidity equilibrium between the surrounding medium and the humidity sensor.

13. The method according to claim 11, wherein a cooling period of the protective layer between heating temperature and cooling temperature is shorter than the dead time.

14. The method according to claim 11, wherein cooling takes place actively or by convective cooling.

15. The method according to claim 11, wherein the heating, cooling, and correction of the measured humidity values are carried out cyclically.
